(19) United States
(12) Patent Application Publication
(10) Pub. No.: US 2014/0123636 A1
(43) Pub. Date: May 8, 2014

(54) HYDROSTATIC TRANSMISSION APPARATUS IMPARTING HIGH DRIVABILITY

(71) Applicants: Andre Prigent, Saintines (FR); Romain Gostomski, Granges (FR)

(72) Inventors: Andre Prigent, Saintines (FR); Romain Gostomski, Granges (FR)

(73) Assignee: POCLAIN HYDRAULICS INDUSTRIE, Verberie (FR)

(21) Appl. No.: 14/112,483

(22) PCT Filed: Apr. 18, 2012
(86) PCT No.: PCT/FR12/50841

§ 371 Date: Dec. 30, 2013

(30) Foreign Application Priority Data
Apr. 18, 2011 (FR) 1153353

(51) Int. Cl. F15B 15/02

(52) U.S. Cl. CPC F15B 15/02
USPC 60/328

(57) ABSTRACT

A hydrostatic transmission apparatus for a vehicle having at least two wheels, the second wheel being steerable, may include a main hydraulic pump, two hydraulic motors driving respective ones of the wheels, detection means for detecting that the second wheel is turned by being steered, a first synchronization duct between the first and second motors, and re-feed means for re-feeding the first synchronization duct, and suitable for acting, while the second motor is being fed by the first motor via the first synchronization duct, and when the second wheel is turned by being steered, to inject fluid into the first synchronization duct while limiting the pressure in said synchronization duct to a pressure less than a re-feed pressure that is significantly less than the high pressure of the pump.

### CROSS-REFERENCE TO RELATED APPLICATIONS

This application is a National Stage filing under 35 U.S.C. §371 of International Application No. PCT/FR2012/050841, filed Apr. 18, 2012, which claims priority to French Patent Application No. FR1153353, filed Apr. 18, 2011, the contents of each of which are incorporated by reference herein.

### FIELD OF THE INVENTION

The invention relates to hydrostatic transmission apparatus for a vehicle having at least a first vehicle mover member and a second vehicle mover member, disposed in succession in the direction of movement of said vehicle, the second member being steerable relative to the vehicle, the apparatus comprising:

a main hydraulic pump having two orifices, and two main ducts, respectively for feed and for discharge;

a first hydraulic motor and a second hydraulic motor that are connected to the main pump for driving respective ones of said first and second mover members;

a first synchronization duct suitable for transferring fluid from the first hydraulic motor to the second hydraulic motor;

detection means suitable for detecting that the steering angle of said steerable member has reached or is exceeding a predetermined value; and

re-feed means for re-feeding the first synchronization duct and that are suitable, while the second motor is being fed by the first motor via the first synchronization duct, and when the detection means detect that said steering angle of the steerable member has reached or is exceeding said predetermined value, for injecting fluid into the first synchronization duct.

In order to simplify the description below, it is considered that all of the vehicle mover members are wheels. However, it should be understood that the invention also applies to vehicles having other types of mover member, e.g. such as a compactor roller, etc.

In addition, in this document, the terms “synchronization duct” or “set of associated synchronization ducts” designate a duct (or a set of associated ducts) that connect the discharge orifices of one or more “upstream” hydraulic motors to the feed orifices of one or more “downstream” other hydraulic motors, and that do not have any branch-off or fork provided for permanently exchanging fluid with the remainder of the hydraulic circuit, at least in a “synchronized” operating mode in which the synchronization duct(s) serve(s) to synchronize the motors interconnected by it/them. In this operating mode, the synchronization duct(s) thus has/have a fluid flow rate that is identical at the inlet and at the outlet. Therefore, they/it synchronize(s) the motors that they/it interconnect(s).

Usually, a single synchronization duct connects a single upstream motor to a single downstream motor. In which case, since the motors have equal cylinder capacities, the synchronization duct ensures that the speeds of rotation of the wheels driven by the motors are the same. As a result, in practice, the wheels advantageously cannot race or spin.

In another configuration, a plurality of ducts are associated and jointly connect the discharge orifices of one or more upstream motors to the feed orifices of one or more downstream motors. The synchronization ducts associated in this way do not have any branch-off or fork provided for a permanent exchange of fluid with the remainder of the hydraulic circuit. The association of the synchronization ducts then requires the total fluid flow rate of the upstream motor(s) to be equal to the total fluid flow rate of the downstream motors. As a result, the upstream and downstream motors are synchronized.

Synchronization ducts can, in particular, be used for synchronizing the motor(s) coupled to one or more rear wheels of a vehicle, with the motor(s) coupled to one or more front wheels of the same vehicle.

In addition, the presence of a synchronization duct or associated synchronization ducts does not exclude operating modes in which the upstream and downstream motors are not synchronized, such as, for example, a one-wheel-drive operating mode on a vehicle having two driven wheels, or a two-wheel-drive operating mode on a vehicle having four driven wheels.

Apparatus of the above-mentioned type is used, in particular, in vehicles that are to be driven on sloping terrain or on banked terrain. In such vehicles, connecting two motors together in series makes it possible to synchronize the wheels that are coupled to them, thereby avoiding spinning of those wheels.

However, although synchronizing the wheels is useful when going straight, it is a hindrance when turning because the various wheels of the vehicle then travel distances that are different as a function of the radii of curvature of their respective paths.

Since they have to travel different distances, the two wheels must therefore rotate at different speeds. It can thus be understood that the motor of one of the wheels, namely the wheel that rotates slower, receives or delivers, via the synchronization duct, a flow rate of fluid that is too high relative to the flow rate of fluid that the motor of the other wheel must deliver or receive.

Thus, synchronizing the wheels tends to prevent any turning, which might make the vehicle unusable or at least very impractical to use.

It has thus been necessary to develop solutions for overriding the synchronization of the motors when turning, and for restoring the handling of such vehicles when they are turning.

Apparatus of the type presented in the introduction is either transmission apparatus that is fed from the rear (i.e. apparatus in which the rear motors are fed with the high pressure of the pump), or transmission apparatus that is fed from the front.

The present invention relates to hydrostatic transmission apparatus fed by the motor coupled to the non-steerable wheel (in general, the rear wheel), and not to apparatus that is fed by the motor coupled to the steerable wheel (in general the front wheel).

Hydraulic transmission apparatus that is fed by the non-steerable wheel and of the type presented in the introduction is known, in particular, from Document FR 2 709 454, in the particular case of a vehicle having two steered front wheels and two non-steered rear wheels.

When a vehicle of that type is going round a turn, the front inner wheel travels a much larger distance than the rear inner wheel, in particular because the rear inner wheel must hardly advance during the turn in order to maintain a small turning radius.

If the front and rear inner motors remain synchronized by the synchronization duct during the turn, that gives rise to a lack of torque for the front wheel, with the risk that said front wheel might start slipping or skidding, causing the vehicle to go straight on instead of going round the turn.

In order to avoid such behavior and in particular in order to avoid slippage of the front inner wheel when going round a turn, Document FR 2 709 454 makes provision so that, during a turn, in addition to the fluid injected into the synchronization duct by the rear motor, an additional quantity of fluid is injected into the synchronization duct, via a re-feed duct fed by the delivery duct of the pump. The injection of fluid into the re-feed duct is triggered by a sensor when said sensor detects that the steering angle of the front wheels has reached a predetermined limit value.

In addition, in order to prevent an excessive quantity of fluid from being injected in this way towards the front motor by the re-feed duct, in the apparatus presented by that document, a constriction is provided in the re-feed duct. That constriction makes it possible to limit the flow rate injected into the synchronization duct by the re-feed duct and thus to prevent the front inner motor from racing.

When the vehicle is at a standstill, the flow rate through the re-feed duct is zero, and there is therefor no head loss through the constriction. Therefore, the delivery pressure of the pump is applied not only to the feed, but also to the discharge of the rear inner motor, so that said rear inner motor delivers no torque. Because of the lack of torque on the rear inner wheel during a turn, the vehicle disclosed by Document FR 2 709 454 is difficult to start moving again, and can even be impossible to start moving again if the outer wheels are in a low-grip zone.

An object of the invention is thus to remedy that drawback by proposing transmission apparatus of the type presented in the introduction that offers good drivability when going round a turn, including at very low speed, or when starting to move.

This object is achieved with the apparatus of the type set out in the introduction by the fact that, in the apparatus, during the injection of fluid into the first synchronization duct that takes place while the second motor is being fed by the first motor via the first synchronization duct, and when the detection means detect that the steering angle of the steerable member reaches or exceeds said predetermined value, the re-feed means are suitable for limiting the pressure in the first synchronization duct to a pressure less than or equal to a re-feed pressure that is significantly less than the high pressure of the pump.

The term “pressure that is significantly less than” means here that the re-feed pressure is less than the high pressure of the pump by at least a predetermined value. This value may be:

fixed, and, for example, equal to 20 bars; or else

proportional to the high pressure of the pump, with a predetermined coefficient of proportionality that is less than one. When said value is proportional, the drive motor available for the rear motor increases with increasing high pressure of the pump, and the distribution of torque between the rear motor and the front motor remains balanced for any value for the high pressure of the pump.

The re-feed pressure can thus be limited by the re-feed means to a pressure less than a re-feed pressure that, for example, is equal to 80% of the high pressure of the pump or to 90% of the high pressure of the pump.

Throughout this document, the term the “high pressure of the pump” designates the pressure prevailing in the main duct of the pump that is at the higher pressure.

In apparatus of the invention, in a turning situation (i.e. once a sufficient steering angle has been detected), fluid is injected into the synchronization duct. As a result of the extra feed (or re-feed) relative to the usual inflow of fluid coming from the discharge orifice of the rear motor, the second motor (in general situated at the front) is able to develop drive torque. It can, in particular, develop high torque, if the quantity of fluid injected causes the pressure in the synchronization duct to represent a significant fraction of the high pressure of the pump. It thus contributes to the handling of the vehicle during turning.

In addition, the injection of fluid into the synchronization duct makes it possible to increase the distance traveled by the steerable mover member, thereby limiting or preventing slippage thereof.

Furthermore, the pressure prevailing in the synchronization duct is maintained significantly lower than the high pressure of the pump. As a result, there is a significant pressure differential between the feed and the discharge of the rear motor. For this reason, the rear motor also develops drive torque, in a turning situation. Advantageously, the presence of drive torque in the rear motor, by means of the above-mentioned pressure differential, and the presence of drive torque in the front motor, by means of the inflow of re-feed fluid, ensures that the vehicle has good drivability, including when starting to move and at low speed.

The apparatus of the invention may, in particular be installed in vehicles having more than two mover members. A first embodiment of the apparatus thus relates, in particular, to vehicles having two front wheels (or mover members) and two rear wheels (or mover members). In this embodiment, the apparatus is designed for a vehicle further having third and fourth vehicle mover members, the fourth member being steerable relative to the vehicle and being constrained to have the same steered angle as the second member; the apparatus further includes third and fourth hydraulic motors; the third and fourth hydraulic motors are suitable for being coupled to respective ones of the third and fourth mover members; a second synchronization duct exists between the third hydraulic motor and the fourth hydraulic motor; and the re-feed means are suitable for acting, while the second and fourth motors are being fed by respective ones of the first and third motors via the first and second synchronization ducts, and when the detection means detect that the steering angle of the steerable member reaches or exceeds said predetermined value, to inject fluid into the first and second synchronization ducts while limiting the pressure in the first and second synchronization ducts to a pressure less than or equal to the re-feed pressure.

The apparatus defined in this way thus has two synchronization ducts that synchronize the respective rotations firstly of the first and second motors, and secondly of the third and fourth motors. Advantageously, the detection and re-feed means are put in common and re-feed the two synchronization ducts simultaneously. This thus makes it possible to maintain drive torque in both of the rear motors, and to increase the distance traveled by the steerable wheels (in general situated at the front) while the vehicle is turning, thereby limiting or preventing slippage of said steerable wheels.

Other embodiments may, in particular, be used for vehicles having three driven wheels, the steerable wheel being the second wheel:

In a first configuration, the apparatus is designed for a vehicle also having a third vehicle mover member; the apparatus further includes a third hydraulic motor suitable for being coupled to the third vehicle mover member; a second synchronization duct exists between the third hydraulic motor and the second hydraulic motor and is arranged such that external connector fittings of the first and third hydraulic motors are jointly connected to an external connector fitting of the second hydraulic motor. The first and second synchronization ducts are then associated in the hydraulic transmission apparatus.

In a second configuration, the apparatus is designed for a vehicle also having a third vehicle mover member; the apparatus further includes third and fourth hydraulic motors; the third and fourth hydraulic motors being coupled together and being suitable for being coupled jointly to the third mover member; a second synchronization duct exists between the third hydraulic motor and the fourth hydraulic motor; the re-feed means are suitable for acting, while the second and fourth motors are being fed by respective ones of the first and third motors via the first and second synchronization ducts, and when the detection means detect that the steering angle of the steerable member reaches or exceeds said predetermined value, to inject fluid into the first and second synchronization ducts while limiting the pressure in the first and second synchronization ducts to a pressure less than or equal to the re-feed pressure. In the preceding sentence, the fact that the third and fourth motors are coupled together means that their respective outlet members (or shafts) are connected together so as to have exactly the same speed of rotation permanently. For example, they can have a single common outlet shaft.

The two preceding configurations make it possible, in simple manner, to drive the three wheels of the vehicle in which the apparatus is mounted, while, in particular, providing high degrees of drivability and of handling during turning.

The functions of the re-feed means may be performed by two functional modules:

The function of the first module is to supply fluid brought to the high pressure of the pump. For this purpose, in an embodiment, this module takes fluid coming from that one of the main ducts of the pump that is at the higher pressure. In order to take said fluid, the re-feed means may be connected to the pump via a shuttle valve connected to the two main ducts of the pump.

Using the fluid brought to the high pressure of the pump, the function of the second module is to supply fluid brought to a regulated pressure referred to as the “re-feed” pressure, which pressure is significantly less than the high pressure of the pump. Said fluid brought to the re-feed pressure may be obtained by means of the facts that the re-feed means are suitable for maintaining the pressure in an enclosure at the re-feed pressure, and that the apparatus further includes a re-feed duct making it possible to inject fluid from the enclosure into the first synchronization duct.

The term “enclosure” is used herein to designate any confined or delimited space in which the pressure can thus be controlled. The enclosure may have any shape and, for example, be a chamber, pipe, a port of a valve, etc.

By injecting the fluid brought to the re-feed pressure into the synchronization duct, the re-feed means then make it possible to maintain the re-feed pressure (or optionally a pressure less than said re-feed pressure) in the first synchronization duct, and thus to perform their function.

In this embodiment, the safety of the synchronization duct may be increased if the apparatus further comprises an anti-overpressure device, suitable for removing fluid from the synchronization duct to said enclosure when the pressure in said synchronization duct exceeds the re-feed pressure. The anti-overpressure device may, in particular, comprise a link duct connecting the synchronization duct to the enclosure and a valve disposed on the link duct, which valve allows fluid to flow only from the synchronization duct towards the enclosure. In which case, the synchronization duct is protected against overpressures because, in the event of an abnormal rise in pressure, it can remove fluid towards said enclosure at regulated pressure.

However, it may be useful to inhibit the anti-overpressure device, in order to enable the first motor to be synchronized with the second motor via the first synchronization duct. For this purpose, the apparatus may further include means for isolating the anti-overpressure device, which means are suitable for inhibiting operation of the anti-overpressure device when the detection means detect that the steering angle of the steerable member is less than said predetermined value.

For the same purpose, the apparatus may further comprise means for isolating the re-feed means, which means are suitable for acting, when the detection means detect that the steering angle of the steerable member is less than said predetermined value, to isolate the re-feed means from the first synchronization duct, in such a manner as to prevent any exchange of fluid between said re-feed means and said synchronization duct.

In order to supply fluid under the re-feed pressure, using the fluid brought to the high pressure of the pump, the re-feed means may comprise a pressure reducer valve having a first inlet port suitable for being maintained at the high pressure of the pump, said enclosure being constituted by an outlet port of the valve, said valve being suitable for maintaining in said outlet port a pressure that is substantially proportional to the pressure in said inlet port with a coefficient of proportionality less than one (the term “less than” meaning “strictly less than” here).

This reducer valve may be a progressive valve having two positions, and further includes a second inlet port, and two opposing hydraulic chambers, namely a first chamber connected to the outlet port, and a second chamber connected to the inlet port;

in which valve return means combined with the pressure in the first chamber tend to bring the reducer valve back into the first position, the pressure in the second chamber tending, conversely, to bring the reducer valve back into the second position;

in which valve the second inlet port is connected to the outlet port while the first inlet port is isolated, when the reducer valve is in the first position; and

in which valve the first inlet port is connected to the outlet port while the second inlet port is isolated, when the reducer valve is in the second position.

Advantageously, in the apparatus of the invention, the re-feed means include limiter means for limiting the flow-rate of fluid injected into said first synchronization duct.

This limitation may, in particular, be made by means of an adjustable constriction. This makes it possible to avoid an excessive quantity of fluid being injected into the synchronization duct and causing the front motor to race, and the front wheel to spin.

The invention can be well understood and its advantages appear more clearly on reading the following detailed description of embodiments shown by way of non-limiting example. The description refers to the accompanying drawings, in which:

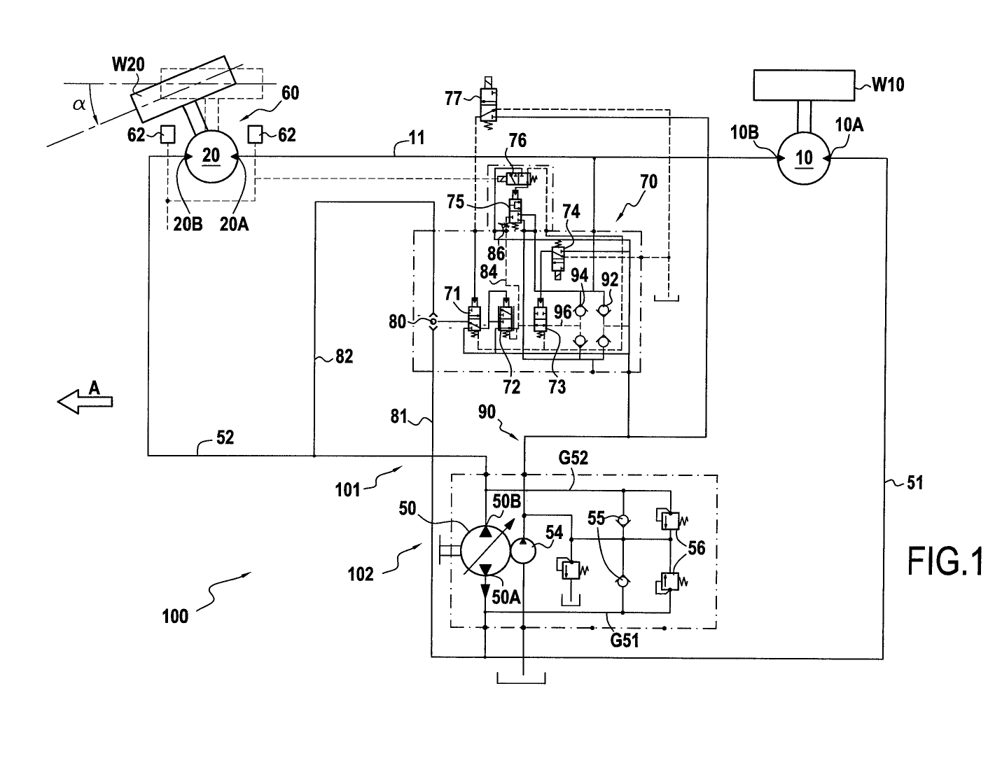

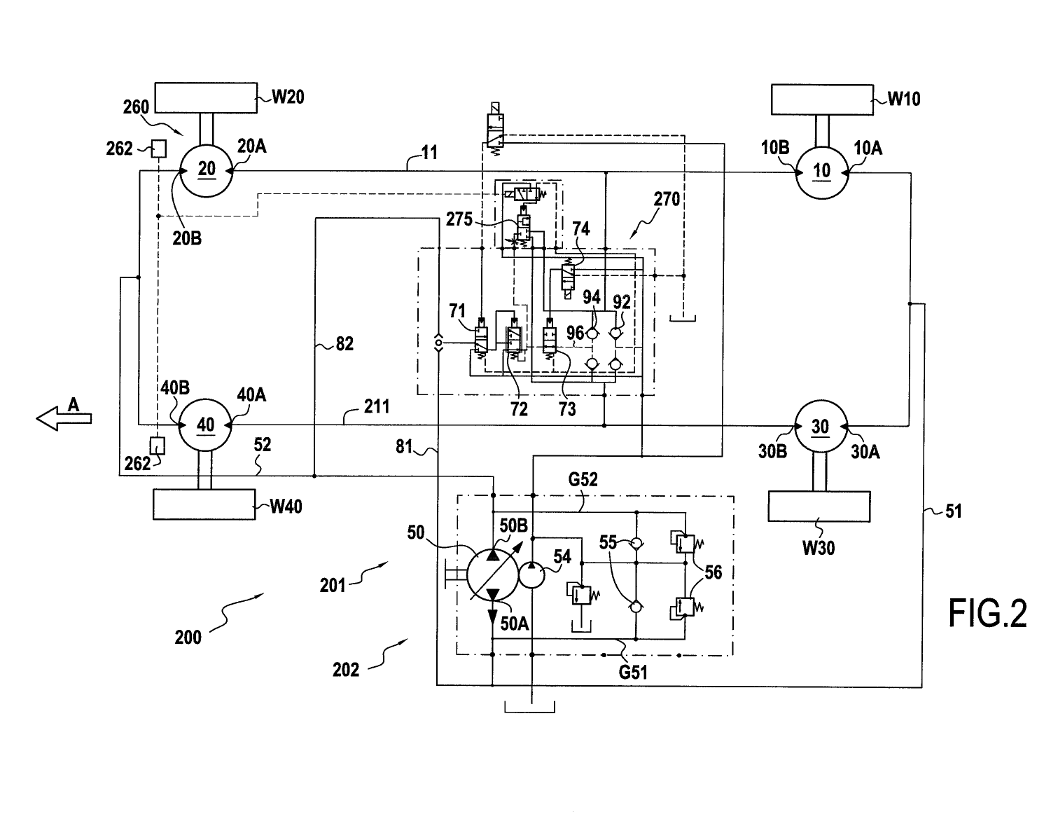

FIGS. 1 and 2 are diagrammatic views of apparatus of the invention, installed respectively on a vehicle having two wheels and on a vehicle having four wheels;

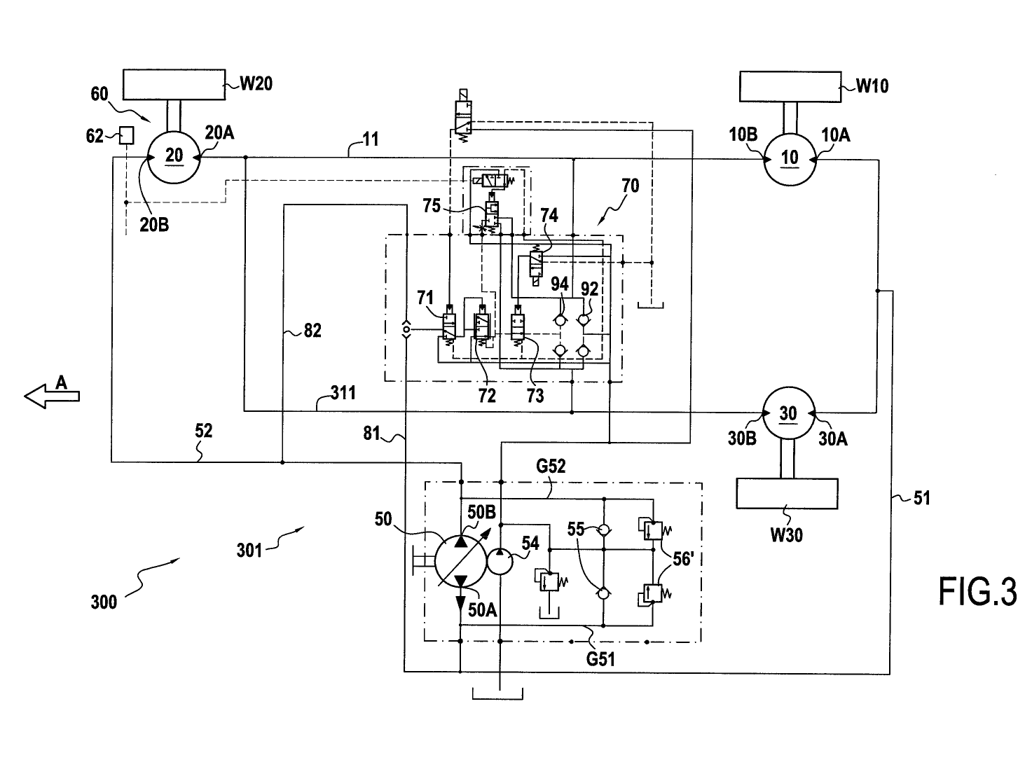

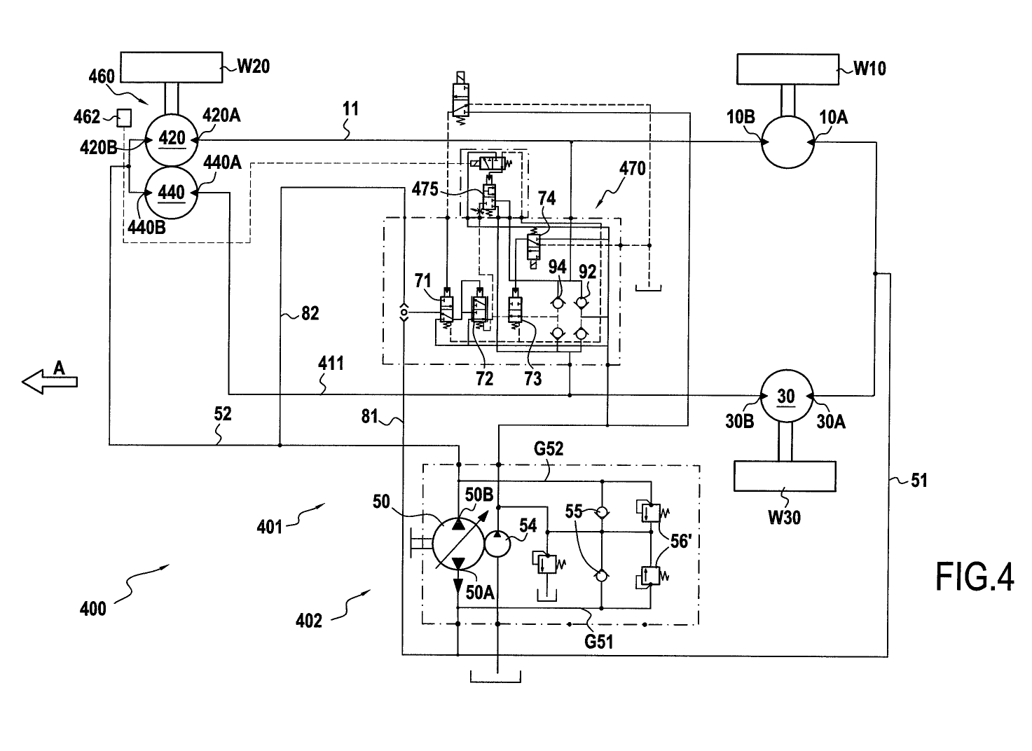

FIGS. 3 and 4 are diagrammatic views of apparatus of the invention, installed on vehicles having three wheels, but in two different circuit configurations; and

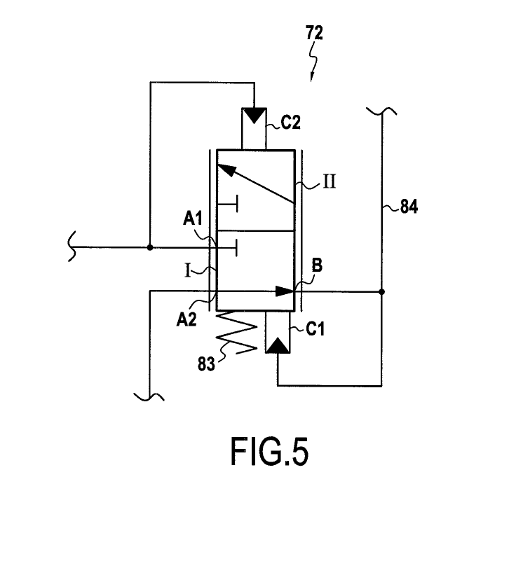

FIG. 5 is a diagrammatic view of a pressure reducer valve used in the preceding apparatus.

FIG. 1 shows a vehicle 100 in which apparatus 101 of the invention is mounted.

The vehicle 100 has two driven wheels that are its vehicle mover members: a rear wheel W10 and a front wheel W20. Naturally, the rear wheel is situated behind the front wheel in the direction in which the vehicle 100 usually travels, this direction being symbolized by arrow A.

The apparatus 101 makes it possible to drive either the rear wheel only (operating in “one-wheel-drive” mode), or both of the wheels (operating in “two-wheel-drive” mode). Firstly, explanations are given below about the “two-wheel-drive” mode.

The front wheel W20 is the steered wheel of the vehicle. For that purpose, it is angularly positionable relative to the vehicle. It can thus pivot about a vertical axis, and form a steering angle α relative to the axis of the vehicle.

The wheels W10 and W20 are driven by respective ones of first and second hydraulic motors 10 and 20. These motors on the vehicle 100 are single motors, i.e. they are not made up of a plurality of elementary motors. However, the apparatus of the invention may also be installed in a vehicle in which one or more of the motors are motors that are each made up of a plurality of elementary motors.

The vehicle 100 also has an internal combustion engine (not shown), e.g. a diesel engine. The engine drives a main hydraulic pump 50 that is part of the transmission apparatus 101. The pump 50 converts the mechanical energy from the engine into hydraulic energy, and that hydraulic energy is transmitted by the hydraulic transmission apparatus 101 to the wheels of the vehicle that propel it.

The pump 50 is a pump having a variable delivery rate, and having two orifices 50A and 50B.

The apparatus 101 includes a fluid transfer circuit 102. The fluid transfer circuit has two main ducts serving the pump 50, namely one main duct 51 connected to the orifice 50A and one main duct 52 connected to the orifice 50B. In a manner known per se, the circuit 102 has a boost circuit 90 including a booster pump 54 that can act via check valves 55 to feed the ducts 51 or 52 with fluid via ducts G51 and G52 in order to avoid cavitation in the motors. Two pressure limiters 56 protect the ducts 51 and 52 from overpressure via the ducts G51 and G52.

Each of the two motors 10 and 20 is a single motor and has two external connector fittings, the references of which are the number of the motor followed by the letter A or B. Naturally, that does not exclude the possibility that, in other embodiments of the invention, one or more of these motors might be a motor having a plurality of active operating cylinder capacities, which are then controlled in a manner internal to the motor. The above-mentioned connector fittings constitute the terminals of the motors.

The first connector fitting 10A of the motor 10 is connected permanently to the first main duct 51. The second connector fitting 20B of the motor 20 is connected permanently to the second main duct 52.

Secondly, the second connector fitting 10B of the first motor 10 is connected to the first connector fitting 20A of the second motor 20 via a synchronization duct 11. Thus, the circuit 102 makes it possible to feed the motor 10 and the motor 20 in series via the pump 50. The synchronization duct 11 is connected to the boost circuit 90 via a valve 92, thereby making it possible at all times to maintain at least a minimum pressure equal to the delivery pressure of the booster pump or “boost pressure”.

A characteristic of having two motors 10 and 20 connected together in series is that the two motors must have equal flow rates and thus, in particular if the motors 10 and 20 and the wheels W10 and W20 are identical, the wheels W10 and W20 must rotate at the same speed. This property advantageously makes it possible, in general, to avoid any spinning of the wheels.

In forward operation, the pump delivers the fluid via its orifice 50A. Thus, via the duct 51, it feeds the motors in the vehicle 100 from the rear, i.e., more precisely, the rear motor 10 is fed first, at the delivery pressure of the pump, while the front motor 20 receives only a fraction of that pressure via the synchronization duct 11 (except in braking and/or downhill situations).

Conversely, for reverse operation, the direction in which fluid is pumped by the pump is reversed, and it is the front motor that receives the fluid at the delivery pressure of the pump (also except in braking and/or uphill situations).

In order to enable the vehicle to turn, and as indicated above, it is, however, necessary to decouple the wheels W10 and W20 from each other. For this purpose, the apparatus 101 further includes detection means 60 that are suitable for detecting that the steering angle α of the wheels has reached or is exceeding a predetermined value. These means comprise, in particular, all-or-nothing sensors 62, such as, for example, proximity detectors or contactors. The sensors 62 are disposed in such a manner that either one of them or the other of them is activated as soon as the steering angle of the wheels reaches a predetermined limit value, e.g. 10° leftwards or rightwards.

The apparatus further includes re-feed means 70 for re-feeding the synchronization duct 11. These means 70 make it possible, when the sensors 62 detect that the steering angle α of the wheel W20 has reached at least 10° (as the predetermined limit value), to inject fluid into the synchronization duct 11 in order to maintain the pressure therein at a re-feed pressure less than a maximum re-feed pressure, such a maximum re-feed pressure being substantially proportional to the high pressure of the pump with a coefficient of proportionality less than one.

The apparatus 101 includes a control unit (not shown) that makes it possible to transmit control information between the various components, in particular between the detection means 60 and the re-feed means for re-feeding the synchronization duct 70.

For performing their various functions, the means 70 include a switch-over valve 71 for switching between one-wheel-drive mode and two-wheel-drive mode, a pressure reducer valve 72, a deactivation valve 73, and deactivation pilot valve 74, and a re-feed inhibit/activate valve 75.

The means 70 take fluid from one or the other of the main ducts 51 and 52 as a function of their pressure, via a shuttle valve 80. The shuttle valve is connected via two link ducts 81 and 82 respectively to the ducts 51 and 52. The shuttle valve 80 thus makes it possible to take fluid at the high pressure of the pump. That fluid is directed towards a first inlet port A1 of the pressure reducer valve 72 via the valve 71, when the valve 71 is in its default position. The part played by the valve 71 is described below.

The reducer valve 72 is described below with reference to FIG. 5. The valve 72 is a progressive valve having two positions I and II. It has the above-mentioned first inlet port A1, a second inlet port A2, an outlet port B, and two opposing hydraulic chambers, namely a first chamber C1 connected to the outlet port B and a second chamber C2 connected to the first inlet port A1.

The valve 72 is equipped with return means that, in addition to the pressure in the first chamber C1, tend to bring the reducer valve back into the first position I, in a manner opposing the pressure in the second chamber C2 that tends, conversely, to bring the reducer valve back into the second position II. These return means are constituted by a single return spring 83 (FIG. 5) that is a relatively weak spring. The function of this return spring is to place the valve in the first position when the pressure in the port C2 remains low, e.g. equal to the boost pressure.

When the reducer valve is in the first position I, the second inlet port A2 is connected to the outlet port B while the first inlet port A1 is isolated; when the reducer valve is in the second position II, the first inlet port A1 is connected to the outlet port B while the second inlet port A2 is isolated.

The valve 72 is a specific valve arranged in such a manner that the pressure in the outlet port is regulated by the valve 72 to a value proportional to the pressure applied to the first inlet port A1, insofar as the pressure in the second inlet port A2 remains low relative to said pressure applied to the first inlet port, which it does in the apparatus 101 as explained below.

The coefficient of proportionality is preferably chosen to be less than 90%, e.g. equal to 80%.

A valve suitable for performing such a function is, for example, the valve referenced 80 and presented by the Applicant's French Patent Application FR 2 913 218. In that valve, the pressure ratio between the pressure in the inlet port A1 and the outlet port B is obtained by means of the fact that the pressures prevailing in the control chambers C1 and C2 are exerted respectively on surfaces of a ratio that is equal to that ratio.

In the circuit 102, the boost circuit 90 is connected to the second inlet port A2 of the valve 72. Thus, the pressure that is applied in the port A2 is the delivery pressure of the booster pump. Since this pressure is very considerably lower than the high pressure of the pump, the valve 72 does indeed regulate the pressure in its outlet port B to a “re-feed pressure” that is proportional to the high pressure of the pump.

The port B of the valve 72 is connected via a “re-feed duct” 84 and via the re-feed inhibit/activate valve 75 to the synchronization duct 11.

The valve 75 has a hydraulic control chamber, the pressure of which is controlled by a pilot solenoid valve 76. Depending on the value taken by this pressure, the valve 75 either allows fluid to pass or prevents fluid from passing; it therefore acts as an activate valve (or, conversely, as an inhibit valve) for the re-feed means 70. It can thus make it possible to activate the re-feed means 70, by allowing the re-feed fluid to pass through the duct 84 so as to feed the synchronization duct 11 and so as to maintain the pressure therein. Conversely, it can prevent any fluid from passing into the duct 84; it then constitutes isolation means for isolating the re-feed means 70. When the valve 75 is in the isolation position, the synchronization duct 11 transmits all of the flow rate output by the motor 10 to the motor 20 (in forward operation), and then fully performs its function of synchronizing the motors 10 and 20 and thus the wheels W10 and W20.

The pilot solenoid valve 76 is activated by the angle detection means 60, i.e. essentially by the sensors 62. More precisely, when the steering angle α remains within the range −10° to +10°, the sensors do not detect anything in particular, and the valve 76 is not activated. Conversely, as soon as the angle α reaches or exceeds +10° or −10°, the valve 76 is activated. By going into the activated position, it triggers an increase in pressure in the hydraulic chamber of the valve 75, which is activated in its turn, and becomes open. The fluid exiting from the valve 72 and regulated to the re-feed pressure is then injected via the duct 84 into the synchronization duct 11.

However, an adjustable constriction 86 (flow rate limiter means) is disposed in the duct 84, between the valves 72 and 75. This constriction ensures that the flow rate in the duct 84 remains limited; it also results in the pressure in the synchronization duct 11 not reaching the re-feed pressure, but rather at a pressure less than said re-feed pressure, because of the head loss caused by the constriction 86. Limiting the flow rate in the duct 84 prevents the motor 20 from racing, e.g. when the wheel W20 loses its grip, e.g. on a slippery surface.

The effect of the apparatus 70 is as follows:

When the vehicle 100 is in forward operation, the motor 10 thus being fed at the delivery pressure of the pump, and if, on going round a turn, the front wheel W20 pivots through more than 10° relative to its normal position, the re-feed means 70 are triggered and inject fluid into the synchronization duct 11. As a function of the adjustment of the constriction 86, the pressure in this duct reaches a pressure that, in practice, is quite close to the re-feed pressure. In the embodiment described, the re-feed pressure is about 80% of the high pressure of the pump.

The pressure in the synchronization duct 11 is then at a little less than 80% of the high pressure of the pump. (In particular, it cannot exceed the re-feed pressure, regardless of the speed of the vehicle, including when it is at a standstill.) Thus, advantageously, the front motor develops high drive torque, and participates to a large extent in the turning of the vehicle.

In addition, the front motor has increased feed relative to the discharge of the rear motor on its own (the “re-feed”) and it can rotate significantly faster than the rear motor 10, thereby enabling the front wheel W20 to travel a distance that is significantly larger than the distance traveled by the rear wheel W10.

Conversely, the difference in pressure across the terminals of the rear motor 10 then drops to about only 20% of the high pressure of the pump: The motor then develops only low drive torque, but nevertheless continues to impart drive and steerage capacity, thereby contributing positively to movability and handling during the turn.

Thus, the vehicle 100 is capable of going round the desired turn, including at very low speed or while stopping and starting, because both of the front and rear motors continue to impart drive throughout the turn.

Conversely, when the vehicle is going straight, the means 70 are deactivated because the valve 75 remains in its closed position. They then do not play any part, and the front motors play only a very reduced drive part.

It should be noted that the apparatus also provides its anti-spin function when the vehicle needs to make a turn while it is on a steep downhill slope, and/or when it is necessary to brake. In known manner, in such situations, the motors do not operate as motors, but rather as pumps. If the vehicle 100 is going round a turn, the front wheel W20 must travel a longer distance than the rear wheel W10. Therefore, overpressure tends to appear in the synchronization duct 11.

Thus, even if the relative pressures in the circuit are inverted relative to the usual operating mode of the vehicle, the direction of the flow of fluid has not changed: it is still the rear motor W10 that feeds the front motor W20. Therefore, it is also necessary, under such conditions, to re-feed the synchronization duct 11 in order to avoid spinning of the front wheel. The means 70 perform this function via the valves 72 and 75, whenever the steering angle exceeds ±10°.

The apparatus 101 also offers the following improvements:

It also has a switch-over control valve 77 for controlling switching-over from one-wheel-drive to two-wheel-drive. Said valve 77 is a solenoid valve that controls the above-mentioned switch-over valve 71 for switching over from one-wheel-drive to two-wheel drive, which valve is a hydraulic valve.

The valve 77 is a two-position valve that makes it possible to constrain the pressure in the hydraulic control chamber of the hydraulic valve 71 to be low or to be high, as applicable. As a function of this pressure, the valve 71 takes up a first position or a second position.

In the first position, as indicated above, the valve 71 enables fluid to flow from the shuttle valve 80 to the valve 72 and thus enables the synchronization duct to be re-fed, if necessary. It does not influence the flow of fluid from the rear motor towards the front motor, and thus makes “two-wheel-drive” mode operation possible.

Conversely, in the second position, the valve 71 enables fluid to flow from the boost circuit 90 to the first inlet port A1 of the valve 72. Under these conditions, the outlet port B, the duct 84, and therefore the synchronization duct 11 are also brought to the boost pressure.

Indeed, when the same pressure is applied to the inlet ports A1 and A2 of the valve 72, the pressure in the outlet port B can only be said same pressure. The pressure reducer 72 acts between a high pressure and a low pressure; if the two pressures are identical, the regulation slide is not in an equilibrium position, and the port A2 is connected directly to the port B. As a result, the boost pressure is indeed applied in the port B and in the synchronization duct 11.

Therefore, the front motor 20 is deactivated and no longer generates any drive torque. All of the available power is thus transmitted by the rear motor 10, thereby enabling the vehicle to operate in a “one-wheel-drive” mode.

In addition, a valve 94 is provided in the apparatus 101 to avoid any excessive rise in pressure in the synchronization duct 11.

The risk of a rise in pressure in the synchronization duct 11 may occur during turning in reverse operation. In such a situation, the front motor 20 tends to send back more fluid to the motor 10 than said motor can absorb, because the rear wheel W10, since it is non-steerable, is caused to rotate slower than the front wheel; the motor 10 thus tends to rotate slower than the motor 20, thereby causing a rise in pressure in the synchronization duct 11.

Under such circumstances, it is thus necessary to remove fluid from the synchronization duct 11.

For that purpose a link duct 96 connects the synchronization duct to the outlet port B of the valve 72 through the valve 94. However, said valve 94 allows fluid to pass towards the valve 72 only.

By means of the construction of the valve 72, the pressure in the port B of said valve is regulated to the “re-feed pressure”, namely, in the example shown, to a pressure that is 80% of the high pressure of the pump. (If necessary, the surplus fluid is removed towards the boost circuit via the second inlet port A2 of the valve 72, which is connected to this circuit.)

Therefore, if the pressure in the synchronization duct tends to rise, the duct 96 removes fluid from the synchronization duct via the duct 94 whenever the pressure in the synchronization duct 11 exceeds the pressure in the port B. Thus, the link duct 96 associated with the valve 94 prevents the pressure in the synchronization duct 11 from exceeding the re-feed pressure and constitutes an anti-overpressure device.

However, the hydraulic valve 73 controlled by the solenoid valve 74 makes it possible to deactivate said apparatus if necessary, when the detection means detect that the steering angle of the steerable member is less than 10°. It thus constitutes isolation means for isolating the anti-overpressure device. It can be understood that if fluid coming from the synchronization duct 11 is removed, the function of synchronizing the wheels that should be performed by the series feed of the motors 10 and 20 is no longer performed.

Under various circumstances, the driver of the vehicle may wish to force the front wheel and the rear wheel to be synchronized. The valves 73 and 74 make it possible to achieve this in the following manner:

The valve 73 is a progressive valve having two positions and interposed on the duct 96. In the default or inactivated position, the valve 73 is open and enables fluid to flow in the duct 96. By activating the valve 74, and thus the valve 73 (controlled by the valve 74), the valve 73 is caused to go into its isolation position, in which it prevents any fluid flow in the duct 96. The fluid can then no longer be removed, in the event of overpressure, via the duct 96 towards the boost circuit 90, which therefore (when going straight) requires the front and rear wheels to be synchronized strictly. Activation of the valve 74 is controlled by the detection means 60, in such a manner as to activate the valve when going straight, and as to deactivate it when going round a turn.

To sum up, in the main operating modes, the apparatus 101 operates as follows:

When going straight, i.e. when the steering angle lies in the range −10° to +10° (as detected by the sensors 62):

The front and rear wheels must be synchronized exactly. For this purpose, the valve 74 is then activated, which places the valve 73 in the isolation position, in which it prevents any output flow from the synchronization duct 11.

In addition, the valve 76 is also activated by the sensors 62, thereby causing the activation valve 75 to go into the isolation position and inhibiting operation of the re-feed means 70.

(However, a possibility of feeding the synchronization duct remains, through the valve 92, in such a manner as to maintain the pressure in the synchronization duct at least at the boost pressure).

Going round a turn (steering angle greater than 10°)

In forward operation:

Following detection of a turn situation by the detection means 60, the valve 76 is activated and causes the valve 75 to go into open mode, thereby triggering fluid injection (and pressure regulation in duct 11) by the re-feed means 70, via the duct 84.

In addition, the valve 74 is also activated, thereby causing the valve 73 to go into open mode too, enabling the duct 96 associated with the valves 94 to perform their anti-overpressure function for the duct 11.

In reverse operation:

It is then necessary to remove fluid from the synchronization duct 11 in order to remove increased pressure therein. For this purpose, as soon as a turn situation has been detected, the valve 74 is deactivated and the valve 75 is activated (opened), thereby placing the re-feed means 70 in the active position, and making it possible to remove fluid from the synchronization duct 11 towards the valve 72 in the event of overpressure. Due to the way the valve 72 operates, the valves 94 make it possible to remove flow only if the pressure in the synchronization duct exceeds 80% of the high pressure of the pump 50.

In this configuration (in turn mode), the valves 72 and 75 are open. Therefore, fluid is extracted (from the synchronization duct 11) under these conditions both via the valves 94 and via the valve 75.

Since the valve 75 is only dimensioned to enable sufficient fluid to be injected into the synchronization duct to increase the drive torque available on the front wheel in forward operation, while also performing the anti-spin function, it does not make it possible, in reverse operation, to take all of the flow that it would be necessary to extract from the synchronization duct under such circumstances, in particular at high speed. For this reason, the valves 94 have been added in order to provide an additional port for removing flow from the synchronization duct under these turning-while-in-reverse-operation conditions.

FIGS. 2, 3 and 4 show embodiments of the invention as applied to vehicles having three or four wheels. In general, the numerical references are kept in these figures for designating components having the same structure and/or the same function.

In certain situations, components that are similar or equivalent but not identical in any two embodiments bear numerical references that differ by a multiple of one hundred.

FIG. 2 shows apparatus 201 of the invention that is adapted for a vehicle 200 having four wheels W10, W20, W30 and W40. The apparatus 201 includes the same elements as the apparatus 101, but it also has additional elements for transmitting power to two additional wheels W30 and W40.

Thus, the apparatus 201 has two additional hydraulic motors 30 and 40 (additional relative to the motors in the apparatus 101) that are connected in series to a second synchronization duct 211. This duct connects the discharge orifice 30B of the motor 30 to the feed orifice 40A of the motor 40 (using the above-defined notation). The orifice 30A of the motor 30 is connected to the duct 51, while the orifice 40B of the motor 40 is connected to the duct 52.

Although the sensors 262 are disposed differently on the vehicle 200 relative to the vehicle 100, they perform the same function as the sensors 62.

Likewise, the apparatus 270 is extremely similar to the apparatus 70. The various valves of the apparatus 270 are identical to the valves of the apparatus 70 and operate in the same way.

However, the valve 275 has an additional function relative to the valve 75. The difference lies in the fact that the apparatus 270 must re-feed two synchronization ducts 11 and 211 rather than only one. Therefore:

the two valves 92 serve to inject fluid from the boost circuit 290 to respective ones of the synchronization ducts;

the two valves 94 serve to inject fluid from respective ones of the synchronization ducts to the boost circuit 290;

the valve 275 acts not only as an activate/inhibit valve, but also as a flow splitter, by enabling fluid to be injected from the valve 72 not only towards the first synchronization duct 11, but also towards the second synchronization duct 211.

It should be noted that, when going round a turn, the apparatus 201 operates in substantially symmetrical manner, i.e. it organizes distribution of the pressures across the terminals of the four motors involved, in such a manner that said distribution is symmetrical between the left side and the right side of the vehicle. As above, this distribution guarantees the existence of a flow rate and of torque that is relatively low, but not zero, on the rear motors, while most of the torque and of the flow rate are delivered to the front motors.

FIG. 3 shows apparatus 301 of the invention that is adapted for a vehicle 300 having three wheels W10, W20, and W30. The apparatus 301 includes the same elements as the apparatus 101, but it also has additional elements for transmitting power to the additional wheel W30.

Thus, the apparatus 301 has an additional hydraulic motor 30 (additional relative to the motors in the apparatus 101). This motor is connected in series via a second synchronization duct 311 to the feed orifice 20A of the front motor 20, which synchronization duct has a segment in common with the duct 11 and is thus associated therewith, upstream from the feed orifice 20A of the motor 20.

As a result, in this apparatus, the phenomenon of synchronization is partially attenuated, due to the fact that the synchronization ducts branch off from each other, the ducts 11 and 311 meeting at a junction point in order to feed the front motor 20.

The apparatus 301, and in particular the re-feed means for re-feeding the synchronization ducts 11 and 311, operate identically to the apparatus 201 and to the re-feed means 270.

FIG. 4 shows apparatus 401 of the invention that is adapted for a vehicle 400 having three wheels W10, W20, and W30. The apparatus 401 includes the same elements as the apparatus 101, except for the motor 20, and it also has additional elements for transmitting power to the additional wheel W30.

It should be noted that the motor 20 of the apparatus 101 is replaced with a motor made up of two elementary motors 420 and 440 mounted on the same outlet shaft driving the wheel W20.

The elementary motor 420 constitutes the “second motor” in the meaning of the invention.

The feed orifice 420A of the elementary motor 420 is connected via a synchronization duct 411 to the discharge orifice 10B of the motor 10; and the discharge orifice 420B of the elementary motor 420 is connected to the main duct 52.

In addition, the apparatus 401 has an additional hydraulic motor 30 (additional relative to the motors in the apparatus 101). The discharge orifice 30B of the motor 30 is connected in series via a second synchronization duct 411 to the feed orifice 440A of the front elementary motor 440, while the feed orifice 30A of the motor 30 is connected to the main duct 51. The discharge orifice of the motor 440 is also connected to the main duct 52.

The apparatus 401, and in particular the re-feed means for re-feeding the synchronization ducts 11 and 411, operate substantially identically to the apparatus 201 and to the re-feed means 270, as regards the fluid transfer circuit 402.

However, it should be noted that because the two elementary motors 420 and 440 are arranged on the same outlet shaft, the road-handling is not the same for the vehicle 400 as for the vehicle 300, as regards the risk of wheel spin, when a rear wheel has lost grip:

In the apparatus 301, the arrangement of the circuit leads to a certain amount of handling independence between the wheels W10 and W30. Severe loss of grip of the wheel W10 leads to a transfer of torque towards the front over the entire cylinder capacity of the motor 20. The torque to be transmitted to the ground by the wheel W20 is then very high, thereby giving rise to a non-negligible risk of wheel spin. In the apparatus 401, the reaction to loss of grip of a rear wheel (e.g. wheel W10) is different. The transfer of torque takes place to only one of the elementary motors of the front motor (the elementary motor 420): thus, the torque to be transmitted to the ground is lower, thereby limiting the risk of spin and of loss of grip of the front wheel, to the benefit of the handling of the vehicle.

To conclude, spin of the wheel W10 leads to spin of the front wheel more easily in the apparatus 301 than in the apparatus 401. From the point of view of the risk of spin of the front wheels, the apparatus 401 thus offers somewhat higher performance than the apparatus 301, at the price of higher complexity of the front motor.

1. Hydrostatic transmission apparatus for a vehicle having at least a first vehicle mover member and a second vehicle mover member, disposed in succession in the direction of movement of said vehicle, the second member being steerable relative to the vehicle, the apparatus comprising:
a main hydraulic pump having two orifices, and two main ducts, respectively for feed and for discharge;
a first hydraulic motor and a second hydraulic motor that are connected to the main pump for driving respective ones of said first and second mover members;
a first synchronization duct suitable for transferring fluid from the first hydraulic motor to the second hydraulic motor;
detection means suitable for detecting that a steering angle of said steerable member has reached or is exceeding a predetermined value; and
re-feed means for re-feeding the first synchronization duct and that are suitable, while the second motor is being fed by the first motor via the first synchronization duct, and when the detection means detect that the steering angle of the steerable member has reached or is exceeding said predetermined value, for injecting fluid into the first synchronization duct;
wherein, during said injection, the re-feed means are suitable for limiting the pressure in the first synchronization duct to a pressure less than or equal to a re-feed pressure that is significantly less than the high pressure of the pump.

2. Apparatus according to claim 1, wherein the re-feed pressure is proportional to the high pressure of the pump with a coefficient of proportionality less than one.

3. Apparatus according to claim 1, for a vehicle further having third and fourth vehicle mover members, the fourth member being steerable relative to the vehicle and being constrained to have the same steered angle as the second member;
the apparatus further including third and fourth hydraulic motors;
the third and fourth hydraulic motors being suitable for being coupled to respective ones of the third and fourth mover members;
a second synchronization duct existing between the third hydraulic motor and the fourth hydraulic motor;
the re-feed means being suitable for acting, while the second and fourth motors are being fed by respective ones of the first and third motors via the first and second synchronization ducts, and when the detection means detect that the steering angle of the steerable member reaches or exceeds said predetermined value, to inject fluid into the first and second synchronization ducts while limiting the pressure in the first and second synchronization ducts to a pressure less than or equal to the re-feed pressure.

4. Apparatus according to claim 1, for a vehicle also having a third vehicle mover member;
the apparatus further including a third hydraulic motor suitable for being coupled to the third vehicle mover member;
a second synchronization duct existing between the third hydraulic motor and the second hydraulic motor and arranged such that external connector fittings of the first and third hydraulic motors are jointly connected to an external connector fitting of the second hydraulic motor.

5. Apparatus according to claim 1, for a vehicle also having a third vehicle mover member;
the apparatus further including third and fourth hydraulic motors;
the third and fourth hydraulic motors being coupled together and being suitable for being coupled jointly to the third mover member;
a second synchronization duct-existing between the third hydraulic motor and the fourth hydraulic motor;
the re-feed means being suitable for acting, while the second and fourth motors are being fed by respective ones of the first and third motors via the first and second synchronization ducts, and when the detection means detect that the steering angle of the steerable member reaches or exceeds said predetermined value, to inject fluid into the first and second synchronization ducts while limiting the pressure in the first and second synchronization ducts to a pressure less than or equal to the re-feed pressure.

6. Apparatus according to claim 1, wherein the re-feed means are connected to the pump via a shuttle valve connected to the two main ducts of the pump.

7. Apparatus according to claim 1, wherein the re-feed means are suitable for maintaining the pressure in an enclosure at the re-feed pressure, the apparatus further including a re-feed duct making it possible to inject fluid from the enclosure into the first synchronization duct.

8. Apparatus according to claim 7, further comprising an anti-overpressure device suitable for removing fluid from the synchronization duct to said enclosure when the pressure in said synchronization duct exceeds the re-feed pressure.

9. Apparatus according to claim 8, wherein the anti-overpressure device comprises a link duct connecting the synchronization duct to the enclosure and a valve disposed on the link duct, which valve allows fluid to flow only from the synchronization duct towards the enclosure.

10. Apparatus according to claim 8, further comprising means for isolating the anti-overpressure device, which means are suitable for inhibiting operation of the anti-overpressure device when the detection means detect that the steering angle of the steerable member is less than said predetermined value.

11. Apparatus according to claim 7, wherein the re-feed means comprise a pressure reducer valve having a first inlet port suitable for being maintained at the high pressure of the pump, said enclosure being constituted by an outlet port of the valve, said valve being suitable for maintaining in said outlet port a pressure that is substantially proportional to the pressure in said inlet port with a coefficient of proportionality less than one.

12. Apparatus according to claim 11, the reducer valve of which is a progressive valve having two positions, and further includes a second inlet port, and two opposing hydraulic chambers, namely a first chamber connected to the outlet port, and a second chamber connected to the inlet port;
return means combined with the pressure in the first chamber tending to bring the reducer valve back into the first position, the pressure in the second chamber tending, conversely, to bring the reducer valve back into the second position;
the second inlet port being connected to the outlet port while the first inlet port is isolated, when the reducer valve is in the first position;
the first inlet port being connected to the outlet port while the second inlet port is isolated, when the reducer valve is in the second position.

13. Apparatus according to claim 1, wherein the re-feed means include limiter means for limiting the flow-rate of fluid injected into said first synchronization duct.

14. Apparatus according to claim 13, wherein the limiter means for limiting the flow rate comprise an adjustable constriction.

15. Apparatus according to claim 1, further comprising means for isolating the re-feed means, which means are suitable for acting, when the detection means detect that the steering angle of the steerable member is less than said predetermined value, to isolate the re-feed means from the first synchronization duct.
